(19) United States
(12) Patent Application Publication
(10) Pub. No.: US 2026/0175624 A1
(43) Pub. Date: Jun. 25, 2026

(54) PNEUMATIC TIRE

(71) Applicant: Toyo Tire Corporation, Hyogo (JP)

(72) Inventor: Keisuke MATSUBARA, Hyogo (JP)

(21) Appl. No.: 19/415,436

(22) Filed: Dec. 10, 2025

(30) Foreign Application Priority Data
Dec. 23, 2024 (JP) 2024-226459

(51) Int. Cl. B60C 11/03; B60C 11/04

(52) U.S. Cl. CPC B60C 11/0304; B60C 11/04; B60C 2011/0348; B60C 2011/0388; B60C 2011/039

(57) ABSTRACT

A tread includes a first main groove and a second main groove extending along a tire circumferential direction on an inner side in a tire axial direction, a narrow groove extending along the tire circumferential direction on an outer side in the tire axial direction, and from the inner side toward the outer side in the tire axial direction, a first shoulder rib defined by the first main groove, an intermediate rib defined by the first main groove and the second main groove, and a center rib defined by the second main groove and the narrow groove, a groove volume ratio increases in order of the first shoulder rib, the intermediate rib, and the center rib, and the center rib and the intermediate rib protrude outward in a tire radial direction relative to a profile surface of the tread.

### CROSS REFERENCE TO RELATED APPLICATION

The full disclosure of Japanese Patent Application No. 2024-226459 filed on Dec. 23, 2024 including the specification, claims, drawings, and abstract is incorporated herein by reference in its entirety.

### TECHNICAL FIELD

The present disclosure relates to a pneumatic tire.

### BACKGROUND

Among pneumatic tires, rib pattern tires having main grooves, narrow grooves, or the like along a tire circumferential direction (for example, JP 2021-049791 A) are known. The rib pattern tire is characterized in that rolling resistance and tire noise are reduced.

### SUMMARY

### Technical Problem

It should be noted that in a rib pattern tire as described above, consideration may given to reducing a groove volume ratio of a center rib in order to improve handling performance. However, such reduction in groove volume ratio of the center rib leads also to reduction in dispersion of the ground contact pressure, and reduced dispersion of the ground contact pressure in turn leads to deterioration in traction performance.

Therefore, the present disclosure advantageously provides a pneumatic tire that can simultaneously achieve both preferable handling performance and preferable traction performance.

### Solution to Problem

A pneumatic tire according to the present disclosure is a pneumatic tire that includes a tread and has a specified mounting direction with respect to a vehicle, in which the tread includes a first main groove and a second main groove extending along a tire circumferential direction on an inner side in a tire axial direction, a narrow groove extending along the tire circumferential direction on an outer side in the tire axial direction, and from the inner side toward the outer side in the tire axial direction, a shoulder rib defined by the first main groove, an intermediate rib defined by the first main groove and the second main groove, and a center rib defined by the second main groove and the narrow groove, the shoulder rib, the intermediate rib, and the center rib being formed such that a groove volume ratio increases in order of the shoulder rib, the intermediate rib, and the center rib, and the center rib and the intermediate rib protrude outward in a tire radial direction relative to a profile surface of the tread.

### Advantageous Effects of Invention

According to the pneumatic tire of the present disclosure, preferable handling performance and preferable traction performance can be simultaneously achieved.

### BRIEF DESCRIPTION OF DRAWINGS

An embodiment of the present disclosure will be described based on the following figures, wherein:

FIG. 1 is a sectional view of a pneumatic tire according to an example of an embodiment;

FIG. 2 is a plan view of a tread of the pneumatic tire according to the example of the embodiment; and

FIG. 3 is a view schematically illustrating a shape of a ground-contact surface of the tread.

### DESCRIPTION OF EMBODIMENTS

Hereinafter, an example of an embodiment of the present disclosure will be described in detail. In the following description, specific shapes, materials, directions, numerical values, etc. are provided as illustrations for facilitating the understanding of the present disclosure, and can be appropriately changed according to applications, purposes, specifications, etc.

### Pneumatic Tire

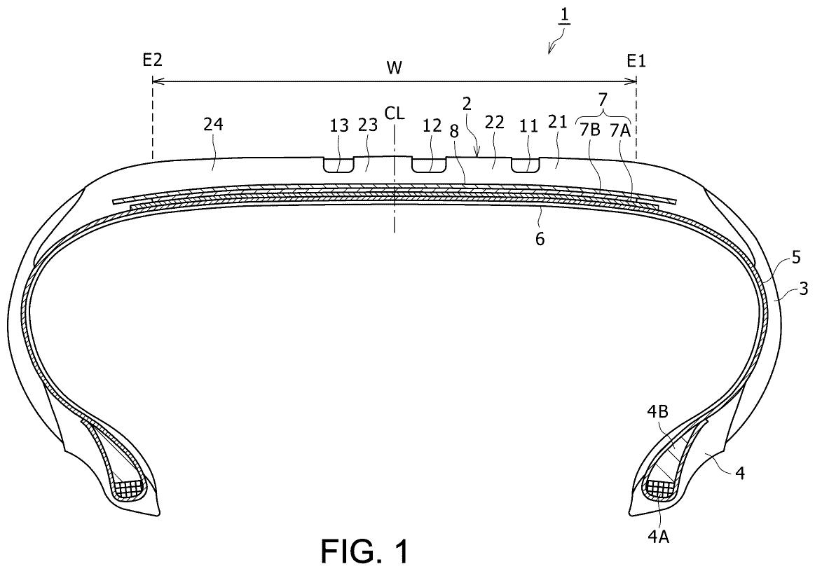

A pneumatic tire 1, which is an example of an embodiment, will be described with reference to FIG. 1.

The pneumatic tire 1 has a tread 2 which is a portion that comes in contact with a road surface, side walls which each form a side surface of a tire, and beads 4 each of which are fixed to a rim of a wheel. The pneumatic tire 1 is suitable, for example, for a semi-racing tire with high acceleration performance.

The pneumatic tire 1 is a tire having a specified mounting direction with respect to a vehicle, and therefore opposite mounting directions on the right side and the left side of the vehicle. That is, the tread 2 has different tread patterns on the left and right sides of a tire equator CL. Here, the tire equator CL is an imaginary line along the tire circumferential direction, and the tire equator CL passes through a center of the tread 2 in a tire axial direction. In the present specification, the terms “left” and “right” are used for convenience of description, with “left” and “right” indicating left and right when facing the normal [if the vehicle travels in reverse, the traveling direction will be opposite] traveling direction of the vehicle in a state in which the pneumatic tire 1 is mounted on the vehicle.

The tread 2 is provided with a first main groove 11 and a second main groove 12 formed on an inner side in the tire axial direction, and a narrow groove 13 formed on an outer side in the tire axial direction. The first main groove 11, the second main groove 12, and the narrow groove 13 are formed straight along the tire circumferential direction without curving in the tire axial direction.

The tread 2 is provided with, from the inner side toward the outer side in the tire axial direction, a first shoulder rib 21 defined by the first main groove 11, an intermediate rib 22 defined by the first main groove 11 and the second main groove 12, a center rib 23 defined by the second main groove 12 and the narrow groove 13, and a second shoulder rib 24 defined by the narrow groove 13. The first shoulder rib 21 and the second shoulder rib 24 are formed beyond ground contact ends E1 and E2, respectively. It should be noted that the ribs are portions that protrude outward in a tire radial direction from a position corresponding to a bottom of the first main groove 11 or the second main groove 12, and are also referred to as lands.

Here, the ground contact ends E1 and E2 of the pneumatic tire 1 are defined as opposite ends, in the tire axial direction, of a region (ground contact surface) that contacts a flat road surface when a predetermined load is applied to an unused tire mounted on a normal rim and inflated to a normal internal pressure. The predetermined load corresponds to 88% of the normal load.

It should be noted that herein “normal rim” refers to a rim defined according to a tire standard, and specifically a “standard rim” according to JATMA, or a “measuring rim” according to TRA and ETRTO. The “normal internal pressure” is a “maximum air pressure” according to JATMA, the maximum value described in the table TIRE LOAD LIMITS AT VARIOUS COLD INFLATION PRESSURES according to TRA, and an INFLATION PRESSURE according to ETRTO. The normal internal pressure is usually 180 kPa for tires for passenger vehicles, and 220 kPa for tires labeled Extra Load or Reinforced. The “normal internal pressure” is a “maximum load rating” according to JATMA, the maximum value described in the table TIRE LOAD LIMITS AT VARIOUS COLD INFLATION PRESSURES according to TRA, and a LOAD CAPACITY according to ETRTO.

As will be described in detail below, in the ground contact surface of the tread 2 of the present embodiment, a length of the ground contact surface (contact length) in the tire circumferential direction near each of the ground contact ends E1 and E2 is relatively smaller than a contact length of the ground contact surface on the tire equator CL, so that the ground contact surface of the tread 2 has a shape closer to an elliptical shape. Specifically, the tread 2 is designed such that a rectangular ratio A of the ground contact surface of the tread 2 is between 0.7 and 0.9.

A side wall 3 is disposed on each side of the tread 2 and is formed in an annular shape along the tire circumferential direction. Each side wall 3 is a portion of the pneumatic tire 1 that protrudes furthest outward in the tire axial direction, and is gently curved to protrude outward in the tire axial direction. A function of the side wall 3 is to prevent damage to a carcass 5. The side wall 3 is designed to flex most during a cushioning operation of the pneumatic tire 1, and is typically made of a soft rubber having fatigue resistance.

Each bead 4 is a portion located radially inward of the wire with respect to the side wall 3 and secured to the rim of the wheel. The bead 4 includes a bead core 4A and a bead filler 4B. The bead core 4A is an annular member comprised of a steel bead wire and extending over an entire circumference of the tire, and is embedded within the bead 4. The bead filler 4B has a tapered tip shape extending radially outward of the tire, and is an annular hard rubber member extending over the entire circumference of the tire.

The carcass 5 extends between a pair of beads 4 and is folded back around the bead core 4A for fixation. The carcass 5 includes at least one carcass ply. The carcass ply is formed by covering a carcass cord made of an organic fiber with a coating rubber. The carcass cord is disposed at substantially a right angle (between 80° and 90°, for example) with respect to the tire circumferential direction. Examples of organic fiber used for the carcass cord include polyester fiber, rayon fiber, aramid fiber, or nylon fiber.

An inner liner 6 covers an inner surface of the tire between the pair of beads 4. The inner liner 6 is made of an air permeation resistant rubber, and has a function of maintaining the air pressure of the pneumatic tire 1.

The pneumatic tire 1 further includes a belt 7 disposed radially outward of the tire with respect to the carcass 5, and a cap ply 8 that covers the outer side of the belt 7 in the tire radial direction. The cap ply 8 has a function of reinforcing the belt 7. The number of cap plies 8 may be one or may be two or more.

The belt 7 is disposed radially outward of the tire with respect to a top of the carcass 5, and is provided in an overlapping manner on the outer circumferential surface of the carcass 5. The belt 7 is formed of belt plies including rubber-coated cords arranged in a direction inclined with respect to the tire circumferential direction. The cords of the belt plies may be made of any material, including, for example, an organic fiber such as polyester, rayon, nylon, or aramid, or of a metal such as steel.

In the present embodiment, the belt 7 includes two belt plies 7A and 7B. The cords forming the two belt plies 7A and 7B are arranged to intersect each other between the two belt plies 7A and 7B.

Here, an angle (belt angle) of the cords forming the two belt plies 7A and 7B with respect to the tire circumferential direction may be between 20° and 30°. In a case where the angle of the cords with respect to the tire circumferential direction is within the above-described range, the rectangular ratio A of the ground contact surface of the tread 2 can be easily controlled to between 0.7 and 0.9. This makes it possible to ensure sufficient drainage performance.

### Rib Shape

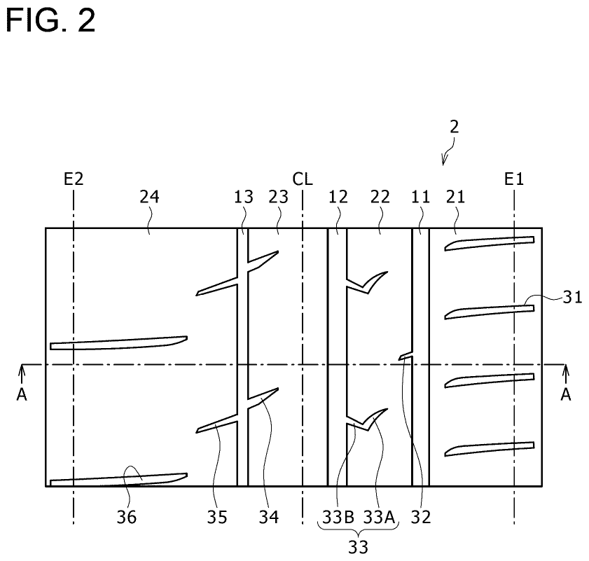

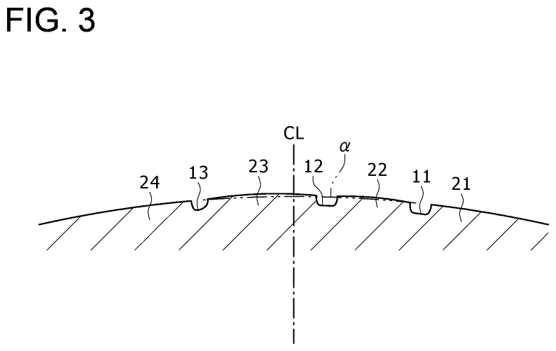

A rib shape, which is an example of the embodiment, will be described with reference to FIGS. 2 and 3.

The tread 2 has a tread pattern that is left-right asymmetric with respect to the tire equator CL. The tread pattern of the pneumatic tire 1 especially significantly exhibits the effects of the present disclosure when the tire is mounted on the vehicle such that the ground contact end E1 side is located on the vehicle inner side and the ground contact end E2 side is located on the vehicle outer side.

As described above, the tread 2 has the first main groove 11 and the second main groove 12 formed on the inner side in the tire axial direction, and the narrow groove 13 formed on the outer side in the tire axial direction. The first main groove 11 and the second main groove 12 are formed on a region on the side of the ground contact end E1 relative to the tire equator CL, and the narrow groove 13 is formed on a region on the side of the ground contact end E2 relative to the tire equator CL.

The first main groove 11, the second main groove 12, and the narrow groove 13 are formed straight in the tire circumferential direction without bending in the tire axial direction. In this case, water on the road surface easily enters the first main groove 11, the second main groove 12, and the narrow groove 13, thereby improving drainage performance. One or more of the first main groove 11, the second main groove 12, and the narrow groove 13 may have a zigzag pattern.

In the present embodiment, the first main groove 11 and the second main groove 12 are formed such that each width thereof is larger than the width of the narrow groove 13. This makes it possible to further improve the drainage performance. The width of the first main groove 11 is the same as the width of the second main groove 12. Each width of the first main groove 11 and the second main groove 12 may be, for example, between 6 and 15 mm, and the width of the narrow groove 13 may be, for example, between 5 mm and 14 mm. The width of the narrow groove 13 may be the same as each width of the first main groove 11 and the second main groove 12, or may be larger than each width of the first main groove 11 and the second main groove 12. In the present specification, the width of the groove refers to a width in a profile surface α along the ground contact surface of the tread 2 unless otherwise specified.

The total of the three groove widths may be set to be not less than 10% of the length W (hereinafter referred to as the “ground contact width W”) along the tire axial direction from the ground contact end E1 to the ground contact end E2. This ensures preferable drainage performance. In addition, superior steering stability can be achieved.

The first main groove 11, the second main groove 12, and the narrow groove 13 have, for example, the same depth. The depth of the first main groove 11, the second main groove 12, and the narrow groove 13 may be, for example, between 2.5 mm and 6.0 mm. The first main groove 11, the second main groove 12, and the narrow groove 13 may have different depths.

At least one of the first main groove 11, the second main groove 12, and the narrow groove 13 is typically provided with a wear indicator (not illustrated). The wear indicator is a projection disposed at the groove bottom and serves as an index for checking the wear level of the tread rubber.

As described above, the tread 2 has, from the inner side toward the outer side in the tire axial direction, the first shoulder rib 21 defined by the first main groove 11, the intermediate rib 22 defined by the first main groove 11 and the second main groove 12, the center rib 23 defined by the second main groove 12 and the narrow groove 13, and the second shoulder rib 24 defined by the narrow groove 13. The first shoulder rib 21, the intermediate rib 22, the center rib 23, and the second shoulder rib 24 are continuously formed in the tire circumferential direction.

The first shoulder rib 21, the intermediate rib 22, and the center rib 23 are formed such that a groove volume ratio increases in order of the first shoulder rib 21, the intermediate rib 22, and the center rib 23. Here, the “groove volume ratio” refers to a groove volume ratio of each rib, or a surface area of a groove (groove such as a slit formed in each rib, excluding the first main groove 11, the second main groove 12, the narrow groove 13, etc. adjacent to each rib) with respect to a surface area of each rib.

With the above-described configuration, in the tread 2, the groove volume ratio increases from the tire equator CL toward the ground contact end E1 (vehicle inner side) in the tire axial direction. In other words, the groove volume ratio is reduced from the ground contact end E1 (vehicle inner side) toward the tire equator CL in the tire axial direction. This makes it possible to improve the handling performance of the pneumatic tire 1.

On the other hand, reduction in the groove volume ratios of the center rib 23 and the intermediate rib 22 leads to reduction in the dispersion of the ground contact pressure, which in turn leads to deterioration in traction performance. Therefore, as will be described in detail below, the center rib 23 and the intermediate rib 22 are formed to protrude outward in the tire radial direction relative to the profile surface α of the tread 2. This makes it possible to suppress the reduction in dispersion of the ground contact pressure. As a result, the traction performance of the pneumatic tire 1 can be improved, enabling the pneumatic tire 1 to simultaneously achieve both superior handling performance and superior traction performance.

### First Shoulder Rib

The first shoulder rib 21 is disposed to be opposite to the intermediate rib 22 in the tire axial direction with the first main groove 11 interposed between the first shoulder rib 21 and the intermediate rib 22. The groove volume ratio of the first shoulder rib 21 is larger than each groove volume ratio of the intermediate rib 22 and the center rib 23, as described above. The width of the ground contact surface of the first shoulder rib 21 may be, for example, between 10% and 30% of the ground contact width W.

A plurality of slits 31 extending in a direction intersecting the first main groove 11 are formed at intervals in the tire circumferential direction in the first shoulder rib 21. In the present specification, a slit refers to a groove having a groove width of 2.0 mm or more.

The slit 31 terminates within the first shoulder rib 21 without being connected to the first main groove 11. Therefore, in the ground contact surface of the first shoulder rib 21, a region near the first main groove 11 is continuous in the tire circumferential direction. This significantly reduces striking sound generated when the first shoulder rib 21 comes into contact with the road surface. As a result, noise performance can be improved. In other words, when the slit 31 is connected to the first main groove 11, the ground contact surface of the first shoulder rib 21 is discontinuous in the tire circumferential direction, which generates additional striking sound when the first shoulder rib 21 comes into contact with the road surface, leading to deterioration in noise performance.

An inner end of the slit 31 in the tire axial direction is disposed axially inward of the tire relative to the ground contact end E1. In addition, an outer end of the slit 31 in the tire axial direction is disposed axially outward of the tire relative to the ground contact end E1. That is, the slit 31 is formed to straddle the ground contact end E1.

The maximum width of the slit 31 may be between 2.0 mm and 6.0 mm. In the deepest portion, the depth of the slit 31 may be substantially the same as the depth of the first main groove 11, or may be between 60% and 95% the depth of the first main groove 11.

### Intermediate Rib

The intermediate rib 22 is disposed to be opposite to the first shoulder rib 21 in the tire axial direction with the first main groove 11 interposed between the intermediate rib 22 and the first shoulder rib 21, and is disposed to be opposite to the center rib 23 in the tire axial direction with the second main groove 12 interposed between the intermediate rib 22 and the center rib 23. A width W2 of the intermediate rib 22 is, for example, between 12% and 17% of the ground contact width W.

The groove volume ratio of the intermediate rib 22 is smaller than the groove volume ratio of the first shoulder rib 21 and larger than the groove volume ratio of the center rib 23, as described above. This makes it possible to improve the handling performance of the pneumatic tire 1, also as described above.

The intermediate rib 22 protrudes outward in the tire radial direction relative to the profile surface α of the tread 2. Here, the profile surface α is a surface along the surface of the tread 2. The protruding height of the intermediate rib 22 from the profile surface α of the tread 2 is within a range from 0.5 to 1.0% of the width W2 of the intermediate rib 22. This makes it possible to suppress the reduction in dispersion of the ground contact pressure by reducing the groove volume ratio of the intermediate rib 22. As a result, the traction performance of the pneumatic tire 1 can be improved.

A plurality of slits 32 and 33 extending in a direction intersecting the first main groove 11 and the second groove 12, respectively, are formed at intervals in the tire circumferential direction in the intermediate rib 22.

The slit 32 is formed from the first main groove 11 toward the tire equator CL, and terminates within the intermediate rib 22. The slit 32 may be formed from the first main groove 11 to the second main groove 12.

The length of the slit 32 in the tire axial direction may be, for example, between 10% and 30% of the width of the intermediate rib 22. The maximum width of the slit 32 is, for example, between 2.0 mm and 6.0 mm. The slit 32 is typically formed to be narrower than the first main groove 11. The depth of the slit 32 may be, for example, between 60% and 95% of the depth of the first main groove 10.

The slit 32 extends along a direction inclined toward one side in the tire circumferential direction with respect to the tire axial direction. The inclined angle of the slit 32 with respect to the tire axial direction may be, for example, between 10° and 50°. The slit 32 may have a zigzag pattern.

The slit 33 is formed from the second main groove 12 toward the ground contact end E2, and terminates within the intermediate rib 22. The slit 32 may be formed from the second main groove 12 to the first main groove 11.

The length of the slit 33 in the tire axial direction may be, for example, between 30% and 80% of the width of the intermediate rib 22. The width of the slit 33 is, for example, between 2.0 mm and 6.0 mm. The depth of the slit 33 may be, for example, between 60% and 95% of the depth of the first main groove 11.

The slit 33 includes a slit 33A extending along a direction inclined toward one side in the tire circumferential direction with respect to the tire axial direction, and a slit 33B curved in a middle portion and extending along a direction inclined toward the other side in the tire circumferential direction. The inclined angle of the slit 33A with respect to the tire axial direction may be, for example, between 30° and 70°. The inclined angle of the slit 33B with respect to the tire axial direction may be, for example, between 10° and 50°.

### Center Rib

The center rib 23 is formed on the tire equator CL. In the present embodiment, the center rib 23 has a center in the tire axial direction that is disposed on a side of the ground contact end E2 relative to the tire equator CL. The width of the center rib 23 is, for example, between 15% and 20% of the ground contact width W.

The groove volume ratio of the center rib 23 is smaller than the groove volume ratio of each of the first shoulder rib 21 and the intermediate rib 22, as described above. This makes it possible to improve the handling performance of the pneumatic tire 1, also as described above.

The center rib 23 protrudes outward in the tire radial direction relative to the profile surface α of the tread 2. By maintaining the protruding height of the center rib 23 from the profile surface α of the tread 2 is within a range from 0.5 to 1.0% of a width W3 of the center rib 23, it becomes possible to suppress the reduction in dispersion of the ground contact pressure by reducing the groove volume ratio of the center rib 23. As a result, superior traction performance of the pneumatic tire 1 can be assured.

Slits 34 are formed in the center rib 23. The slits 34 are formed at predetermined intervals in the tire circumferential direction. Each slit 34 is formed from the narrow groove 13 toward the tire equator CL, and terminates within the center rib 23. The slit 34 has a length extending from the narrow groove 13 and not reaching the tire equator CL. The slit 34 may have a length extending from the narrow groove 13 and reaching the tire equator CL, or may be formed to extend from the narrow groove 13 to the second main groove 12.

The length of the slit 34 in the tire axial direction may be, for example, between 20% and 60% of the width W3 of the center rib 23. The width of the slit 34 is, for example, between 2.0 mm and 6.0 mm. The depth of the slit 34 may be, for example, between 60% and 95% of the depth of the second main groove 12.

The slit 34 extends along a direction inclined toward one side in the tire circumferential direction with respect to the tire axial direction. The inclined angle of the slit 34 with respect to the tire axial direction may be, for example, between 10° and 50°. The slit 34 may have a zigzag pattern.

### Second Shoulder Rib

The second shoulder rib 24 is disposed to be opposite to the center rib 23 in the tire axial direction with the narrow groove 13 interposed between the second shoulder rib 24 and the center rib 23. A width W4 of the ground contact surface of the second shoulder rib 24 may be, for example, between 20% and 50% of the ground contact width W.

A plurality of slits 35 extending in a direction intersecting the narrow groove 13 are formed at intervals in the tire circumferential direction on the inner side of the second shoulder rib 24 in the tire axial direction. A plurality of slits 36 extending in a direction intersecting the narrow groove 13 are formed at intervals in the tire circumferential direction on the outer side of the second shoulder rib 24 in the tire axial direction.

The slits 35 are formed at predetermined intervals in the tire circumferential direction. Each slit 35 is formed from the narrow groove 13 toward the ground contact end E2, and terminates within the second shoulder rib 24. The slit 35 has a length extending from the narrow groove 13 and not reaching the ground contact end E2.

The length of the slit 35 in the tire axial direction may be, for example, between 10% and 40% of the width W4 of the second shoulder rib 24. The width of the slit 35 is, for example, between 2.0 mm and 6.0 mm. The depth of the slit 35 may be, for example, between 60% and 95% of the depth of the second main groove 12.

The slit 35 extends along a direction inclined toward one side in the tire circumferential direction with respect to the tire axial direction. The inclined angle of the slit 35 with respect to the tire axial direction may be, for example, between 10° and 50°. The slit 35 may have a zigzag shape.

The slit 36 terminates within the second shoulder rib 24 without being connected to the narrow groove 13. Therefore, in the ground contact surface of the second shoulder rib 24, a region near the narrow groove 13 is continuous in the tire circumferential direction. This significantly reduces striking sound generated when the second shoulder rib 24 comes into contact with the road surface. As a result, the noise performance can be improved. In other words, when the slit 36 is connected to the narrow groove 13, the ground contact surface of the second shoulder rib 24 is discontinuous in the tire circumferential direction, which generates additional striking sound when the second shoulder rib 24 comes into contact with the road surface, leading to deterioration in noise performance.

An inner end of the slit 36 in the tire axial direction is disposed axially inward of the tire relative to the ground contact end E2. In addition, an outer end of the slit 36 in the tire axial direction is disposed axially outward of the tire relative to the ground contact end E2. That is, the slit 36 is formed to straddle the ground contact end E2.

The maximum width of the slit 36 may be between 2.0 mm and 6.0 mm. In the deepest portion, the depth of the slit 36 may be substantially the same as the depth of the narrow groove 13, or may be between 60% and 95% of the depth of the second main groove 12. [See note in paragraph 0042.]

### Summary

The present disclosure will be further described by the following embodiments.

### Configuration 1

A pneumatic tire comprising a tread and having a specified mounting direction with respect to a vehicle, wherein
the tread includes a first main groove and a second main groove extending along a tire circumferential direction on an inner side in a tire axial direction, a narrow groove extending along the tire circumferential direction on an outer side in the tire axial direction, and from the inner side toward the outer side in the tire axial direction, a shoulder rib defined by the first main groove, an intermediate rib defined by the first main groove and the second main groove, and a center rib defined by the second main groove and the narrow groove,
the shoulder rib, the intermediate rib, and the center rib are formed such that a groove volume ratio increases in order of the shoulder rib, the intermediate rib, and the center rib, and
the center rib and the intermediate rib protrude outward in a tire radial direction relative to a profile surface of the tread.

### Configuration 2

The pneumatic tire described in Configuration 1, wherein
a protruding height of the center rib from the profile surface of the tread is within a range from 0.5 to 1.0% of a width of the center rib, and a protruding height of the intermediate rib from the profile surface of the tread is within a range from 0.5 to 1.0% of a width of the intermediate rib.

### Configuration 3

The pneumatic tire described in Configuration 1, wherein
a ratio of a width of the center rib to a width of the tread is 15% to 20%.

### Configuration 4

The pneumatic tire described in Configuration 1, wherein
a ratio of a width of the intermediate rib to a width of the tread is 12% to 17%.

The present disclosure is not limited to the above-described embodiments and variations thereof, and, as a matter of course, various modifications and improvements can be made without departing from the scope of the claims herein.

### REFERENCE SIGNS LIST

1 pneumatic tire, 2 tread, 3 side wall, 4 bead, 4A bead core, 4B bead filler, 5 carcass, 6 inner liner, 7 belt, 7A, 7B belt ply, 8 cap ply, 11 first main groove, 12 second main groove, 13 narrow groove, 21 first shoulder rib (shoulder rib), 22 intermediate rib, 23 center rib, 24 second shoulder rib, 31 slit, 32 slit, 33 slit, 33A slit, 33B slit, 34 slit, 35 slit, 36 slit, CL tire equator, E1 ground contact end, E2 ground contact end, w ground contact width, W1 width of first shoulder rib, W2 width of intermediate rib, W3 width of center rib, W4 width of second shoulder rib, α profile surface

1. A pneumatic tire comprising a tread and having a specified mounting direction with respect to a vehicle, wherein
the tread includes a first main groove and a second main groove extending along a tire circumferential direction on an inner side in a tire axial direction, a narrow groove extending along the tire circumferential direction on an outer side in the tire axial direction, and from the inner side toward the outer side in the tire axial direction, a shoulder rib defined by the first main groove, an intermediate rib defined by the first main groove and the second main groove, and a center rib defined by the second main groove and the narrow groove,
the shoulder rib, the intermediate rib, and the center rib are formed such that a groove volume ratio increases in order of the shoulder rib, the intermediate rib, and the center rib, and
the center rib and the intermediate rib protrude outward in a tire radial direction relative to a profile surface of the tread.

2. The pneumatic tire according to claim 1, wherein
a protruding height of the center rib from the profile surface of the tread is within a range from 0.5 to 1.0% of a width of the center rib, and a protruding height of the intermediate rib from the profile surface of the tread is within a range from 0.5 to 1.0% of a width of the intermediate rib.

3. The pneumatic tire according to claim 1, wherein
a ratio of a width of the center rib to a width of the tread is 15% to 20%.

4. The pneumatic tire according to claim 1, wherein
a ratio of a width of the intermediate rib to a width of the tread is 12% to 17%.

5. The pneumatic tire according to claim 2, wherein
a ratio of a width of the center rib to a width of the tread is 15% to 20%.

6. The pneumatic tire according to claim 2, wherein
a ratio of a width of the intermediate rib to a width of the tread is 12% to 17%.

7. The pneumatic tire according to claim 3, wherein
a ratio of a width of the center rib to a width of the tread is 15% to 20%.
